(19) United States
(12) Patent Application Publication
(10) Pub. No.: US 2008/0141143 A1
(43) Pub. Date: Jun. 12, 2008

(54) Shared calendaring system and method

(76) Inventors: Kenton O'Hara, Bristol (GB); Guy Adams, Stroud Glos (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/605,028

(22) Filed: Nov. 27, 2006

(30) Foreign Application Priority Data
Nov. 25, 2005 (GB) 0524025.4

(51) Int. Cl. G06F 3/00

(52) U.S. Cl. 715/751

(57) ABSTRACT

A shared calendaring system comprising a printed calendar for recording a desired calendar entry, and an electronic calendaring apparatus operable to process event data representing the desired entry, the system operable to provide feedback to a user of the system representing allowability of the entry in the system on the basis of the processed event data, and corresponding method.

### FIELD OF THE INVENTION

The present invention relates to a calendaring system, and more specifically, but not exclusively, to a shared calendaring system.

### BACKGROUND

Shared electronic calendaring systems are now common place, but have not obviated the use of paper-based calendaring systems, in both domestic and office use. Paper calendars have various important characteristics such as free text entry, visual persistence, being situated and not requiring any boot-up times. Yet they also do not have many of the benefits that people are used to in electronic calendaring systems (e.g., the ability to detect clashes in appointments and the ability to check availability of people or resources such as rooms). In particular, there is no convenient way to manage appointments across multiple paper calendars since there is no way of connecting the information from one paper calendar to the information on another paper calendar and provide feedback at the point of entry to the paper calendar.

There are many examples of both electronic and paper-based calendaring systems. For example, U.S. Pat. No. 5,842,009 describes the automatic retrieval of information relevant to a scheduled event. This is based on a fully electronic set of devices. Further, US 20050024346A1 describes a digital pen with a calendar synchronisation capability. According to US 20050024346A1, a host to pen link can be established in order to provide a calendar reminder function. Other examples exist such as U.S. Pat. No. 6,820,096B1 which describes a so-called smart Calendar, and the electronic calendaring system by Microsoft called Outlook, which enables users to view the availability of others.

None of the described systems allow appointments across multiple paper calendar system to be managed effectively, or provide any feedback to a user at the point of entry of the paper system.

### SUMMARY OF THE PRESENT INVENTION

According to a first aspect of the present invention there is provided a shared calendaring system comprising a printed calendar for recording a desired calendar entry, and an electronic calendaring apparatus operable to process event data representing the desired entry, the system operable to provide feedback to a user of the system representing allowability of the entry in the system on the basis of the processed event data.

According to a second aspect of the present invention there is provided a method of using a calendaring system comprising a printed calendar, the method comprising marking a portion of the printed calendar in order to generate event data representing a desired calendar entry for the system, using the event data in order to determine if an existing or pending event exists for the system which has any one of an overlapping date, time or duration with the desired entry, and on the basis of the determination, providing feedback to a user relating to recordal of the entry in the system.

According to a third aspect of the present invention there is provided a method for recording data for a calendaring system using a printed calendar, the method comprising marking the calendar in order to record at least one of a desired date time, duration and type for an event, using the marking to generating event data for the desired event, comparing the event data with data representing an existing or pending event for the system in order to determine if there is a clash between the time, date and/or duration of the desired event and the existing or pending event, and notifying a user of the system of the result of the comparison.

According to a fourth aspect of the present invention there is provided a computer program, comprising machine readable instructions, wherein said program is arranged, in association with said machine to effect notification to a user of a status of recordal of a desired calendar entry for a shared calendaring system, the desired entry made on a printed calendar of the system.

### BRIEF DESCRIPTION OF THE FIGURES

For a better understanding of the present invention, and to further highlight the ways in which it may be brought into effect, embodiments will now be described, by way of example only, with reference to the following drawings in which:—

FIG. 1 is a schematic representation of a product comprising a data en coding pattern and content;

FIG. 2 is schematic representation of a portion of an exemplary data encoding pattern;

FIG. 3 is a schematic representation of a detector for use with the product of FIG. 1;

FIG. 4 is a flow chart representing an exemplary procedure for generating an entry in a calendar according to an embodiment;

It should be emphasised that the term “comprises/comprising” when used in this specification specifies the presence of stated features, integers, steps or components but does not preclude the presence or addition of one or more other features, integers, steps, components or groups thereof.

### DETAILED DESCRIPTION

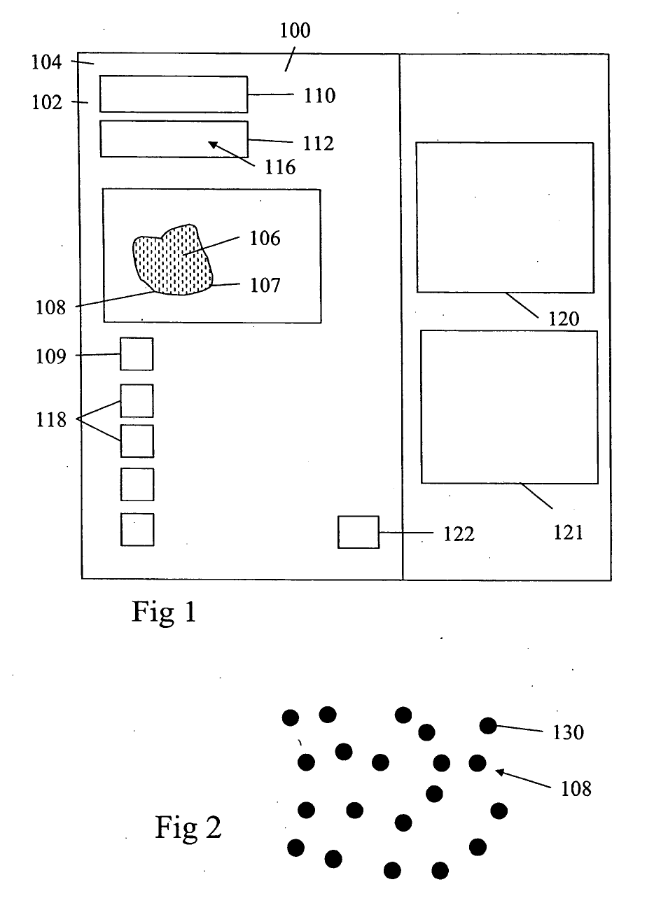

Referring to FIG. 1, a document 100 for use in a digital pen and paper system comprises a carrier 102 in the form of a single sheet of paper 104 with position identifying markings 106 printed on some parts of it to form areas 107 of a position identifying pattern 108. Also printed on the paper 104 are further markings 109 which are clearly visible to a human user of the form, and which make up the content of the document 100. The content 109 will obviously depend entirely on the intended use of the document. The content, format or use of the document described with reference to FIG. 1 is not intended to be limiting.

In this case an example of a calendar page is shown. The content comprises a number of areas 110, 112 which can be pre-printed with user specific information such as dates and times for example 114. The content further comprises a number of check boxes 118 any one of which can be marked by a user, and two larger boxes 120, 121 in which the user can write, as well as some printed text and images.

A position identifying pattern 108 can be printed onto the parts of the form which the user is expected to write on or mark, such as within the check boxes 118, and the boxes 120, 121 for example, or over the entire page.

Referring to FIG. 2, an exemplary position identifying pattern 108 is made up of a number of markings 130. The arrangement of the markings defines an imaginary pattern space, and only a small part of the pattern space need be taken up by the pattern on the document 100. By allocating a known area of the pattern space to the document 100, for example by means of a co-ordinate reference, the document and any position on the patterned parts of it can be identified from the pattern printed on it. It will be appreciated that many position identifying patterns can be used. Some examples of suitable patterns are described in WO 00/73983, WO 01/26033 and WO 01/71643 for example. Alternatively, other position identifying methods for the device can be used. For example, if knowledge of content, for example, printed on a product surface is known, this can be compared with an image of a portion of the product surface generated using an image capture device of the pen. The comparison can be used to determine the pen position relative to the product surface. Other alternatives are possible. For example, a product can comprise pieces of material, such as metal for example. The pen can sense its position by triangulating its position using the pieces of material. For example, the pieces of metal, or other material, can be adapted to have different properties, and the pen can use this fact to determine its position relative to the pieces and hence the product. So, for example, the pen can hold a digital map of the printed content on all the pages of a document. The pen can be pre-programmed with the appearance of the document for example. A camera in the pen then detects any printed content close to the position of the pen tip and searches the stored content to work out exactly where the pen must be (allowing for perspective distortions). Such a pen could not detect absolute position on a blank page (because there would be no content to reference the position from) but could construct relative pen motions (after beginning to write) by imaging the ink from the pen strokes or by using paper fibre sensing technology. Alternatively, a blank page could have content that is printed in invisible IR ink that can be imaged by the camera, but by avoiding the need for invisible ink markings, the document pages could be printed by the user on any available inkjet or laserjet printer, and a mechanism can be provided for loading the appearance of the pages into a digital pen. The pages of the document can be printed to ensure there are always enough visible points of reference. Text boxes, tick boxes, and representations of controls can all be printed to en sure that visually distinct images will be sensed by the camera in the pen to allow it to identify the exact page and position within the page.

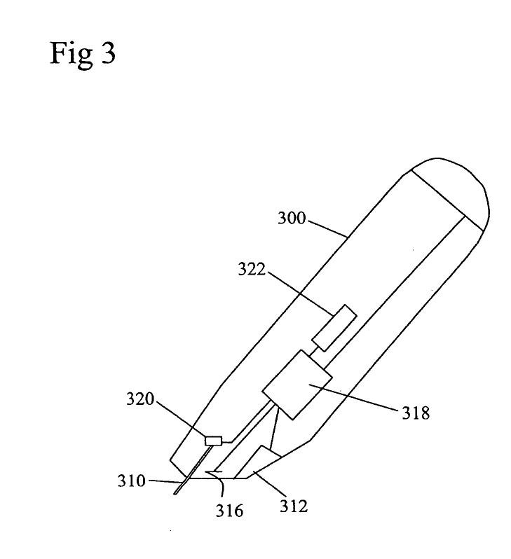

Referring to FIG. 3, a digital pen 300 comprises a writing stylus 310, and a camera 312. The camera 312 is arranged to image an area adjacent to the tip 311 of the pen stylus 310. A processor 318 processes images from the camera 312. A pressure sensor 320 detects when the stylus 310 is in contact with the document 100 and triggers operation of the camera 312. Whenever the pen is being used on a patterned area of the document 100, the processor 318 can therefore determine from the pattern 108 the position of the stylus of the pen whenever it is in contact with the document 100. From this it can determine the position and shape of any marks made on the patterned areas of the document 100. This information is stored in a memory 322 in the pen as it is being used.

The pen can be provided with an output port which can comprise at least one electrical contact that connects to corresponding contacts on a base station (not shown). Alternatively, the pen and base station can communicate wirelessly using an infra-red or radio frequency communications link such as Wi-Fi or Bluetooth for example. Other alternatives are possible. Pen 300 can comprise a display for presenting information to a user such as an LCD display for example, or an OLED display. The pen 300 can comprise a loudspeaker, and/or one or more lights, such as LEDs for example, operable to present information to a user.

Although reference is made herein to a digital pen (and paper system) comprising a camera this is not intended to be limiting, as it will be appreciated that all which is required in order to effectively image a pattern is an image capturing device. Such a device can be incorporated into a number of products, not just a pen. For example, an image capture device can be incorporated into a mobile station such as a mobile telephone or pager, or in a personal digital assistant.

According to an embodiment, pages of a paper calendar can be printed on digital paper such as paper 104, to be read by a detector such as digital pen 300. Markings made on a calendar page by the digital pen can be used to determine calendar data which can be transferred using a wired link or wirelessly over a local or wide area network to a centralised electronic calendar on the network. The centralised calendar is designated as the hub for a particular group of paper calendars.

More specifically, a calendar page printed on digital paper can be used to determine and save timings of appointments, and check if a desired date/time clashes with another event in the calendar. An event can be an appointment for a meeting, a reminder for a task, or other suitable event. For example, spatial positioning of a calendar entry made using pen 300 can be used to determine a particular time of day. As the pen 300 is operable to determine its position relative to the calendar page by virtue of pattern 108, the position of text entry on the paper can be used to determine a desired time and/or date for that text entry. For example, an entry written in the centre of the field for June 21st can be used to designate an appointment beginning at midday on that date. Alternatively, if start times are written as free form text, character recognition of these free form patterns can be used to determine start times and/or dates. There are various ways to designate the length of an event. For example, an arrow drawn from the start time to the end time can represent a desired duration for an event. Alternatively, the duration can specifically be written in, using text or other notation.

Upon making a new entry on a calendar page, the time determined by the spatial positioning or character recognition methods can be transmitted wirelessly from pen 300 over a local or wide area network to the central shared electronic calendar on the network. The date, time and duration is then compared to existing entries from the other paper (and/or electronic) calendars. The other paper and/or electronic calendars are linked to the central electronic calendar for the purposes of providing a hub and centralised repository for the comparison of event data for the calendars.

The centralised electronic calendar sends information over the network to the device (e.g. pen 300) making the calendar entry. This can then be converted into meaningful feedback on the pen 300 according to the pen interface specifications. For example, the pen 300 can vibrate to indicate a clash in a calendar entry. Alternatively, or in combination, an LCD could provide information about the clash/availability, and/or lights could glow (e.g. red or green to indicate, clash/no clash). The centralised calendar can therefore provide real-time feedback to the pen 300 as entries on a calendar are being made. Alternatively, feedback can be given at a time after an entry has been made, such as upon a synchronisation process with the centralised calendar for example.

Other interactions with a paper calendar are possible. For example, if the pen 300 has a suitable display then before attempting to fill in an appointment, a simple tap or double tap on the calendar in the date/time which the user is interested in can initiate the central electronic calendar to transmit any information about this date/time to the pen to be displayed to the user. Another interaction can be to be able to drag and drop appointments on the paper interface. For example, a calendar entry for one date and time can be selected by the user simply by being tapped (once or more for example) using the pen 300. A further tap (or more) in another calendar area representing a different date and/or time can cause the entry to effectively be moved. Alternatively, the entry to be moved can be tapped and held using the pen, and the pen can then be dragged over the calendar to the new desired date and/or time. When the pen is lifted away from the paper, the new entry can take effect. If moving an entry causes a clash, a user can be notified as described above, and prompted to move the original entry to another date and/or time, or delete the entry with which the moved entry clashes. Other alternatives are possible.

The richness of the paper calendar interface can be improved by the use of a ‘buddy list’ or similar whereby specific actions/updates can be sent directly to a defined person/point and also via a defined method e.g. update my parents calendar and send an email/text to notify of the change.

By the physical nature of the interface there are conditions where the calendar would ideally be re-printed in order to reflect changes. This could be an automatic action based on selectable triggers, e.g. electronic entries.

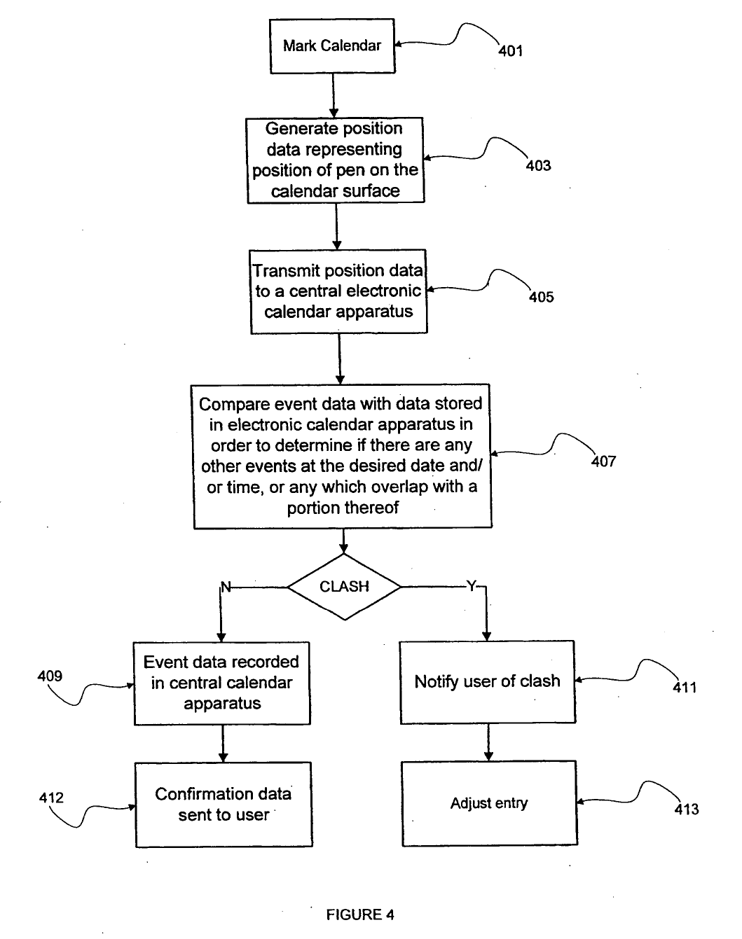

FIG. 4 is a flow chart representing an exemplary procedure for generating an entry in the calendar of FIG. 1. At step 401a user initiates the procedure by marking the calendar using pen 300. The calendar is marked in an area which corresponds to a desired date and time for an event such as an appointment. At step 403, position data is generated by the pen 300 representing the position of the pen on the calendar surface. The position data is generated using the pattern 108 on the calendar page, and can be used to determine which area of the calendar has been marked, and what particular markings have been used by the user.

At step 405, the position data transmitted by pen 300 to a central electronic calendar apparatus. The position data can be decoded in the pen prior to transmission, or upon arrival at the central electronic calendar apparatus. The decoded position data comprises information representing position changes of the pen 300 when being used on the surface of the calendar. Therefore, any marking which were written on the calendar can be determined. The determined markings form event data representing at least one of a desired date, time, duration and type of event. At step 407, the event data is compared with data stored in the central electronic calendar apparatus in order to determine if there are any other events at the desired date and time, or any which overlap with a portion thereof. If there are none, then at step 409 the event data is recorded in the central calendar apparatus. Confirmation data can be sent to the user (412), and this can be fed back using the pen 300. For example, a buzzer can sound indicating that the event is successful, and there are no clashes. Alternatively, a message can be presented to the user using a display of the pen. Further alternatively, a light or lights can be activated to signal to the user that the event is successful. A combination of the above can also be used. Other alternatives are possible.

If, at step 407 it is determined that there is a clash, then at step 411 this information is fed back to the user using one of the aforementioned methods. The user can have the choice of amending (413) the date, time or duration, deleting the proposed event, or deleting the exiting event with which the proposed event has clashed. The deletion of the existing event can be subject to the user having permission to delete it, such as if the user was the person who recorded the existing event for example, or if permission has been given, explicitly or implicitly. A clash can be characterised as occurring when the event in question has a portion of its duration which overlaps with that of an existing or pending event of the system.

The event data recorded in the central electronic calendar can be used in an electronic calendar connected thereto, and can be used for the purposes of comparison with further event data from the same or other users of paper or electronic calendars.

1. A shared calendaring system comprising:
a printed calendar for recording a desired calendar entry; and
an electronic calendaring apparatus operable to process event data representing the desired entry, the system operable to provide feedback to a user of the system representing allowability of the entry in the system on the basis of the processed event data.

2. A system as claimed in claim 1, wherein a marking made on a portion of the printed calendar is used to generate the event data, the data representing at least one of a desired date, time, type and duration of the entry.

3. A system as claimed in claim 1 or 2, wherein the event data is compared with data stored in a memory of the calendaring apparatus representing an existing or pending event for the system, wherein the system is operable to generate feedback on the basis of the comparison.

4. A system as claimed in any preceding claim, wherein feedback is provided by the system using feedback data generated by the calendaring apparatus representing the successful, or otherwise, addition of the entry to the system.

5. A system as claimed in any preceding claim, wherein the printed calendar comprises a data encoding pattern printed on at least a portion thereof, wherein a marking made on a portion comprising the pattern is used to generate event data.

6. A system as claimed in claim 5, wherein event data is generated by:
using the pattern to generate position data representing the position of a portion of the marking on the calendar; and
using the position data to determine at least one of a desired date, time, type and duration of the desired entry.

7. A system as claimed in any preceding claim, further comprising a pen operable to mark a portion of the printed calendar and generate the event data on the basis of the marked portion.

8. A system as claimed in claim 7, wherein the pen comprises at least one of a display, loudspeaker arrangement and other visual and/or aural user notification device adapted to notify a user of the successful, or otherwise addition of the event in the system.

9. A method of using a calendaring system comprising a printed calendar, the method comprising:
marking a portion of the printed calendar in order to generate event data representing a desired calendar entry for the system;
using the event data in order to determine if an existing or pending event exists for the system which has any one of an overlapping date, time or duration with the desired entry; and
on the basis of the determination, providing feedback to a user relating to recordal of the entry in the system.

10. A method as claimed in claim 9, wherein providing feedback to a user further comprises:
generating notification data, wherein the notification data is used to present to a user of the system information relating to recordal of the entry in the system.

11. A method as claimed in claim 10, wherein the notification data is used to present to a user of the system information relating to the fact that the desired entry has been added to the system.

12. A method as claimed in claim 10, wherein the notification data is used to present to a user of the system information relating to the fact that the desired entry clashes with an existing entry of the system and has not been added.

13. A method as claimed in claim 10, wherein an entry is at least one of a desired date, time, type and duration for an event, and wherein a clash occurs when the desired entry has a portion of its duration which overlaps with that of an existing or pending event of the system.

14. A method as claimed in any of claims 10 to 13, wherein the notification data is used to present to a user of the system information relating to addition of the desired entry in the system using at least one of a display and a loudspeaker arrangement and/or other visual or aural notification means.

15. A method for recording data for a calendaring system using a printed calendar, the method comprising:
marking the calendar in order to record at least one of a desired date time, duration and type for an event;
using the marking to generating event data for the desired event;
comparing the event data with data representing an existing or pending event for the system in order to determine if there is a clash between the time, date and/or duration of the desired event and the existing or pending event; and
notifying a user of the system of the result of the comparison.

16. A method as claimed in claim 15, wherein the notification to the user of the system is adapted to present information to the user representing the availability of the date, time and/or duration for the desired event in the system.

17. A method as claimed in claim 15 or 16, wherein the notification takes the form of at least one of a visual and aural notification to the user.

18. A printed calendar for use with the system as claimed in any of claims 1 to 7.

19. A printed calendar for use with the method as claimed in any of claims 7 to 17.

20. A printed calendar as claimed in claim 18 or 19, comprising a data encoding pattern printed on at least a portion thereof.

21. A pen for use with the system as claimed in any of claims 1 to 7, comprising a display for presenting information to a use r of the system representing the successful, or otherwise, addition of the event in the system.

22. A pen adapted to mark a printed calendar for use according to the method as claimed in any of claims 7 to 17.

23. A computer program, comprising machine readable instructions, wherein said program is arranged, in association with said machine to effect notification to a user of a status of recordal of a desired calendar entry for a shared calendaring system, the desired entry made on a printed calendar of the system.

24. A shared calendaring system substantially as hereinbefore described with reference to and as shown in the accompanying drawings.

25. A method substantially as hereinbefore described with reference to and as shown in the accompanying drawings.

26. A pen substantially as hereinbefore described with reference to and as shown in the accompanying drawings.
